(19) United States
(12) Patent Application Publication
(10) Pub. No.: US 2026/0048626 A1
(43) Pub. Date: Feb. 19, 2026

(54) HOLDING DEVICE

(71) Applicant: Kun Yang, Leonberg (DE)

(72) Inventor: Kun Yang, Leonberg (DE)

(73) Assignee: ACPS Automotive GmbH, Ingersheim (DE)

(21) Appl. No.: 19/291,891

(22) Filed: Aug. 6, 2025

(30) Foreign Application Priority Data
Aug. 15, 2024 (DE) 102024123334.6

(51) Int. Cl. B60D 1/48; B60D 1/52

(52) U.S. Cl. CPC B60D 1/488; B60D 1/52

(57) ABSTRACT

In order to improve holding device that is mountable on a rear region of the body of a motor vehicle, comprising a pivotal bearing unit, which is mountable in a manner fixed to the vehicle on the rear region of a motor vehicle, in particular a passenger car, by a carrier unit, and on which a pivot element that carries an attachment element is mounted to pivot about a pivot axis running transversely, in particular obliquely, to a longitudinal center plane and is thus pivotal from a working position to a rest position and vice versa, wherein by way of a connection arm the pivot element is provided with an attachment element carrier that has an insertion receptacle in which an attachment element is insertable and fixable with positive engagement by an end region, wherein in the working position the insertion receptacle extends with its center axis substantially parallel to the longitudinal center plane, and wherein the attachment element carrier comprises a receiving body that has the insertion receptacle, the improvement being such that the receiving body is fixed to the connection arm as inexpensively as possible, it is proposed that the receiving body should be connected to the connection arm by a connecting body that is integrally formed in one piece with the connection arm.

### CROSS-REFERENCE TO RELATED PATENT APPLICATION

The present disclosure relates to the subject matter disclosed in German application number 10 2024 123 334.6 of 15 Aug. 2024, which is incorporated herein by reference in its entirety and for all purposes.

### BACKGROUND OF THE INVENTION

The invention relates to a holding device that is mountable on a rear region of the body of a motor vehicle, comprising a pivotal bearing unit, which is mountable in a manner fixed to the vehicle on the rear region of the motor vehicle, in particular a passenger car, by a carrier unit, and on which a pivot element that carries an attachment element is mounted to pivot about a pivot axis running transversely, in particular obliquely, to a longitudinal center plane and is thus pivotal from a working position to a rest position and vice versa, wherein by way of a connection arm the pivot element is provided with an attachment element carrier that has an insertion receptacle in which an attachment element is insertable and fixable with positive engagement by an end region, wherein in the working position the insertion receptacle extends with its center axis substantially parallel to the longitudinal center plane, and wherein the attachment element carrier comprises a receiving body that has the insertion receptacle.

In holding devices of this kind, the problem is to fix the receiving body to the connection arm as inexpensively as possible.

### SUMMARY OF THE INVENTION

In accordance with an embodiment of the invention, provision is made in the case of a holding device of the kind mentioned in the introduction that the receiving body is connected to the connection arm by a connecting body that is integrally formed in one piece with the connection arm.

A connecting body that is integrally formed in one piece with the connection arm in this manner provides a simple way of making a stable and optimally realizable connection with the receiving body.

A particularly advantageous solution in this context provides for the receiving body and the connecting body to be connected to one another by pressure welding.

The method of pressure welding has the great advantage that it enables an, on the one hand, stable connection of possibly different materials and has a high degree of efficiency and short welding times.

It is particularly advantageous if the receiving body and the connecting body are connected to one another by friction welding, since friction welding enables a particularly efficient and rapidly realizable weld connection.

It is particularly advantageous if the receiving body is connected to the connecting body by rotary friction welding, since rotary friction welding is a particularly advantageous form of friction welding in respect of efficiency and the time required.

So that the rotary welding can be carried out as efficiently as possible, it is preferably provided for the rotary friction welding to be performed by rotating the receiving body about an axis that is parallel to its center axis, in particular about the center axis thereof, since selection of the axis in this manner enables an efficient manufacturing method.

So that rotary friction welding of this kind can be performed efficiently, it is preferably provided for the receiving body to be provided as a finished body, that is to say as a body in a final form for use thereof, with a weld lug that is connected to the connecting body by friction welding.

A weld lug of this kind advantageously makes it possible to realize friction welding to the connecting body.

A favorable solution in this context provides for the weld lug of the receiving body to be arranged on an opposite side of the receiving body to an insertion opening, such that the procedure of friction welding can be realized in a simple manner.

A particularly favorable solution here provides for the connecting body to have a holding face, which faces the receiving body and to which a support face of the weld lug is connected by friction welding.

In particular here, the support face takes the form of an annular face that enables an optimal welding result with rotary friction welding.

A further advantageous embodiment of the solution according to the invention provides for the connecting body to form a body part of the receiving body.

This means that the connecting body itself forms a body part of the receiving body in order to make a reliable and stable connection therewith.

Here, it is preferably provided for the body part to form at least one wall of the receiving body, which is connected to at least one body part of the receiving body that supplements this body part.

This provides a simple and stable way to realize the receiving body with a body part according to the invention.

It is particularly advantageous here if the body part and the at least one supplementary body part are connected to one another by pressure welding.

In this case, a particularly advantageous solution of the object of the invention provides for the body part and the at least one supplementary body part to be connected to one another by friction stir welding, in particular along a gap formed between the body part and the at least one supplementary body part abutting against it.

It is advantageous for friction stir welding of this kind if, for the purpose of connecting the body parts, one of them is provided with steps for receiving side edges in a defined manner and thus for positioning the other body part such that the gap is formed between them.

A concrete embodiment of the holding device according to the invention provides for the body part to form at least two walls of the receiving body.

It is even more advantageous if the body part takes the shape of a U, and thus forms three walls of the receiving body.

In particular in this case, it is provided for the body part to form a side wall and two transverse walls respectively adjoining a side thereof.

In this context, with a body part that is formed in this way, it is favorably provided for the side wall and the transverse walls to be connected in one piece with one another.

In this case, it is furthermore favorably provided for the transverse walls to be connected to one another, on an opposite side to the side wall, by a side wall of the supplementary body part.

Thus, the description above of solutions according to the invention comprises in particular the different combinations of features that are defined by the sequentially numbered embodiments below:

1. A holding device (20) that is mountable on a rear region (14) of the body (12) of a motor vehicle (10), comprising a pivotal bearing unit (30), which is mountable in a manner fixed to the vehicle on the rear region (14) of a motor vehicle (10), in particular a passenger car, by a carrier unit (22), and on which a pivot element (32) that carries an attachment element (50) is mounted to pivot about a pivot axis (36) running transversely, in particular obliquely, to a longitudinal center plane (34) and is thus pivotal from a working position (A) to a rest position (R) and vice versa, wherein by way of a connection arm (38) the pivot element (32) is provided with an attachment element carrier (40) that has an insertion receptacle (46) in which an attachment element (50) is insertable and fixable with positive engagement by an end region (58), wherein in the working position (A) the insertion receptacle (46) extends with its center axis (44) substantially parallel to the longitudinal center plane (34), and wherein the attachment element carrier (40) comprises a receiving body (42) that has the insertion receptacle (46), wherein the receiving body (42) is connected to the connection arm (38) by a connecting body (60, 80) that is integrally formed in one piece with the connection arm (38).

2. The holding device according to embodiment 1, wherein the receiving body (42) and the connecting body (60, 80) are connected to one another by pressure welding.

3. The holding device according to embodiment 2, wherein the receiving body (42) and the connecting body (60, 80) are connected to one another by friction welding.

4. The holding device according to embodiment 3, wherein the receiving body (42) is connected to the connecting body (60) by rotary friction welding.

5. The holding device according to embodiment 4, wherein the rotary friction welding is performed by rotating the receiving body (42) about an axis that is parallel to its center axis (44), in particular about the center axis (44) thereof.

6. The holding device according to embodiment 4 or 5, wherein the receiving body (42) is provided as a finished body with a weld lug (68) that is connected to the connecting body (60) by friction welding.

7. The holding device according to embodiment 6, wherein the weld lug (68) of the receiving body (42) is arranged on an opposite side to an insertion opening (48).

8. The holding device according to embodiment 6 or 7, wherein the connecting body (60) has a holding face (62), which faces the receiving body (42) and to which a support face (64) of the weld lug (68) is connected by friction welding.

9. The holding device according to one of embodiments 1 to 3, wherein the connecting body (80) forms a body part (82) of the receiving body (42′).

10. The holding device according to embodiment 8 or 9, wherein the body part (82) forms at least one wall (84, 86, 88) of the receiving body (42′), which is connected to at least one body part (100) of the receiving body (42′) that supplements this body part (82).

11. The holding device according to embodiment 10, wherein the body part (82) and the at least one supplementary body part (100) are connected to one another by pressure welding.

12. The holding device according to embodiment 11, wherein the body part (82) and the at least one supplementary body part (100) are connected to one another by friction stir welding, in particular along a gap (118) formed between the body part (82) and the at least one supplementary body part (100) abutting against it.

13. The holding device according to embodiment 12, wherein, for the purpose of connecting the body parts (82, 100), one of them is provided with steps (126, 128) for receiving side edges (130) in a defined manner and thus for positioning the other body part (100, 82) such that the gap (118) is formed between them.

14. The holding device according to one of embodiments 9 to 13, wherein the body part (82) forms at least two walls (84, 86, 88) of the receiving body (42).

15. The holding device according to embodiment 14, wherein the body part (82) takes the shape of a U and forms three walls (84, 86, 88) of the receiving body (42).

16. The holding device according to embodiment 15, wherein in the working position (A) the body part (82) forms a side wall (84) and two transverse walls (86, 88) respectively adjoining a side thereof.

17. The holding device according to embodiment 16, wherein the side wall (84) and the transverse walls (86, 88) are connected in one piece with one another.

18. The holding device according to embodiment 17, wherein the transverse walls (86, 88) are connected to one another, on an opposite side to the side wall (84), by a side wall (102) of the supplementary body part (100).

Further features and advantages form the subject matter of the description below and of some exemplary embodiments represented in the drawing.

### BRIEF DESCRIPTION OF THE DRAWINGS

FIG. 1 shows a side view of a motor vehicle with a holding device according to the invention;

FIG. 2 shows a perspective illustration of a first exemplary embodiment of the holding device according to the invention;

FIG. 3 shows a view, in the direction of the arrow A in FIG. 2;

FIG. 4 shows a plan view from above, in the direction of the arrow B in FIG. 2, of the first exemplary embodiment;

FIG. 5 shows a side view, in the direction of the arrow C in FIG. 4, with an inserted attachment element with a coupling ball;

FIG. 6 shows an illustration of the side view according to FIG. 5, without the attachment element inserted;

FIG. 7 shows an illustration of the side view, similar to FIG. 6, before the receiving body is connected to the connecting body;

FIG. 8 shows an illustration of the pivot element and the attachment element carrier of a second exemplary embodiment of the holding device according to the invention, with the attachment unit inserted;

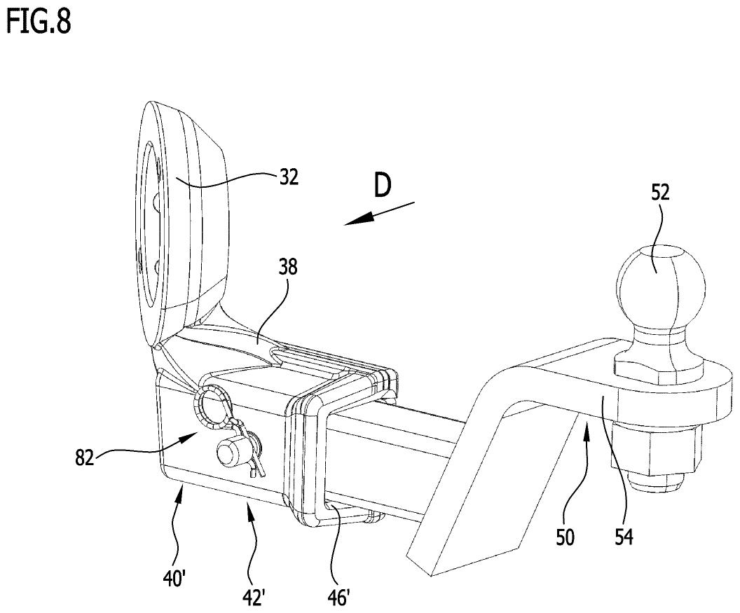

FIG. 9 shows a side view, in the direction of the arrow D in FIG. 8, of the second exemplary embodiment;

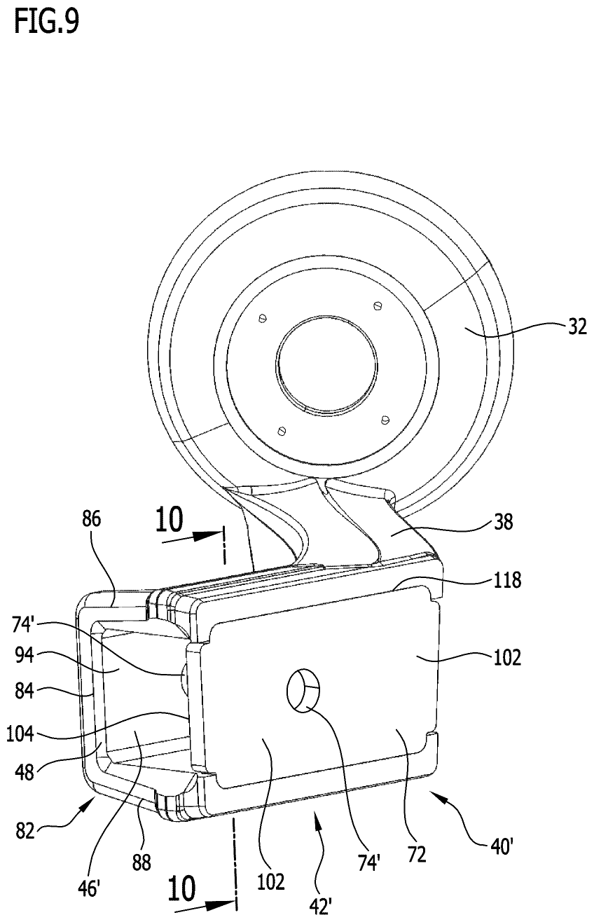

FIG. 10 shows view of a section along the line 10-10 in FIG. 9;

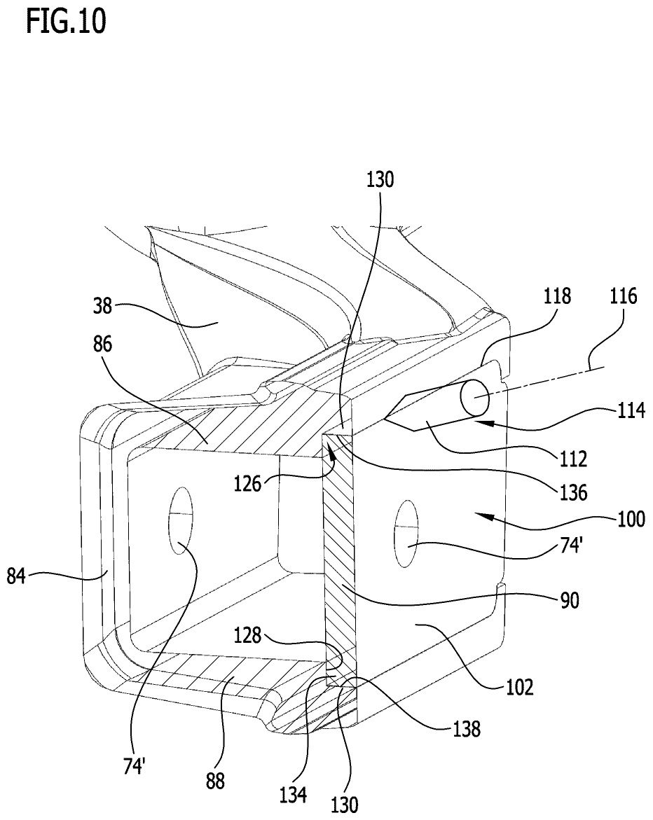

FIG. 11 shows a lateral plan view, similar to FIG. 8, of the pivot element and the attachment element carrier 40″ of a third exemplary embodiment of the holding device according to the invention;

FIG. 12 shows an enlarged perspective view of the third exemplary embodiment, according to FIG. 11; and

FIG. 13 shows a front view of the insertion receptacle according to FIG. 12.

### DETAILED DESCRIPTION OF THE INVENTION

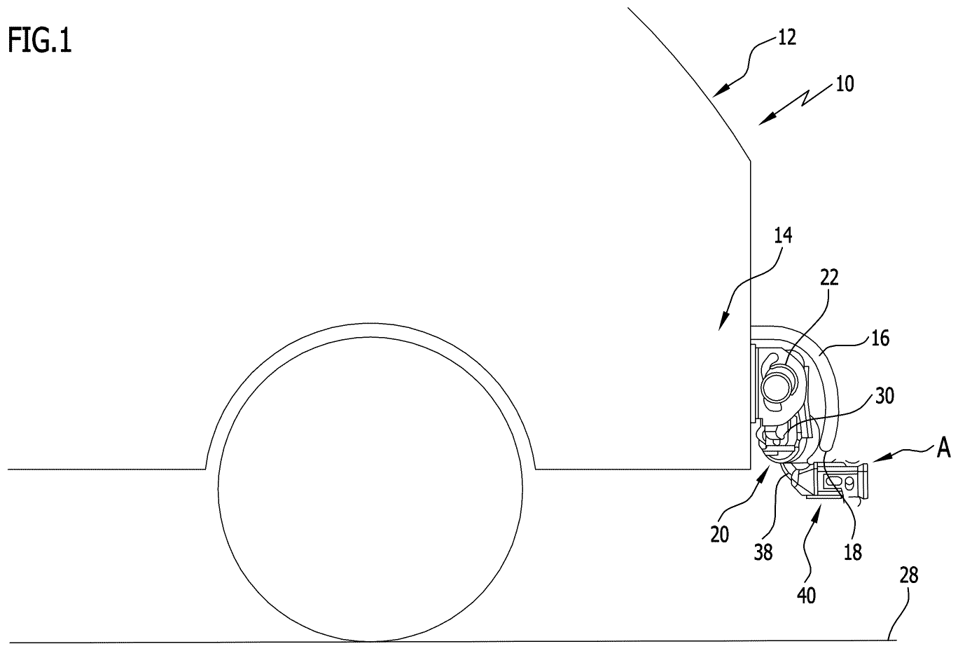

An exemplary embodiment, illustrated in FIG. 1, of a motor vehicle 10 according to the invention comprises a body 12 that carries a rear bumper unit 16 on a rear region 14.

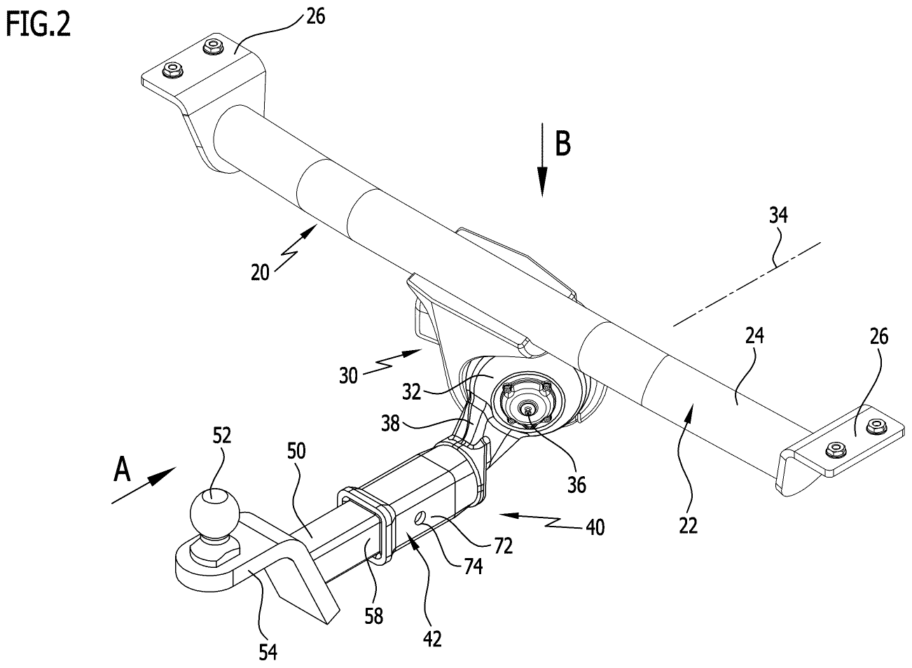

Further, arranged on the rear region is a first exemplary embodiment of a holding device, which is designated 20 as a whole, and which has a carrier unit 22 that is arranged below the bumper unit 16 such that it is hidden by it, wherein the carrier unit 22 comprises, as illustrated in FIG. 2, a transverse carrier 24 that is connected to the rear region 14 by lateral connection elements 26.

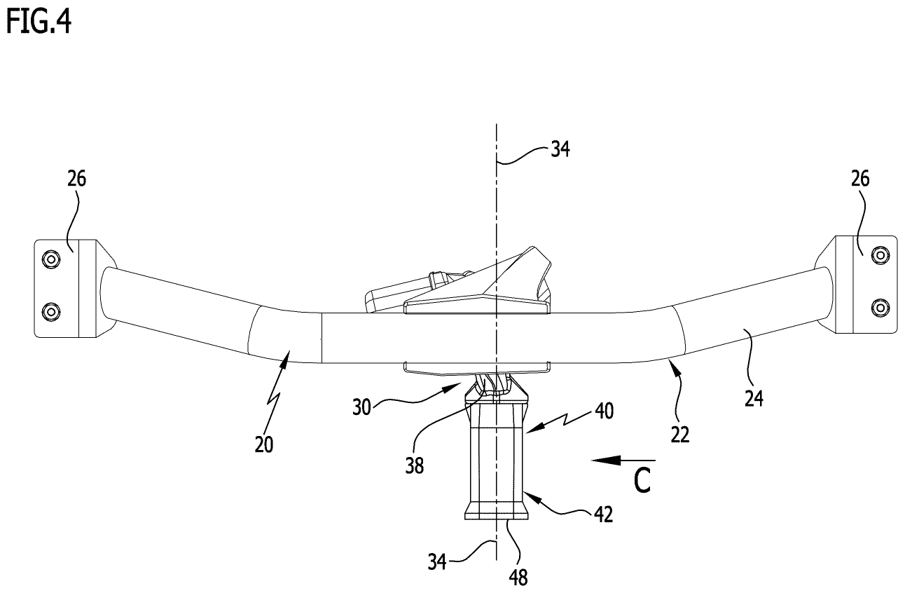

Further, held on the carrier unit 22, in particular in a central region of the transverse carrier 24, is a pivotal bearing unit, which is designated 30 as a whole and on which a pivot element 32 is mounted such that it is pivotal about a pivot axis 36 that extends transversely to a vehicle longitudinal center plane 34 of the body 12, which is at the same time also a longitudinal center plane 34 of the holding device 20 (FIGS. 2 to 4).

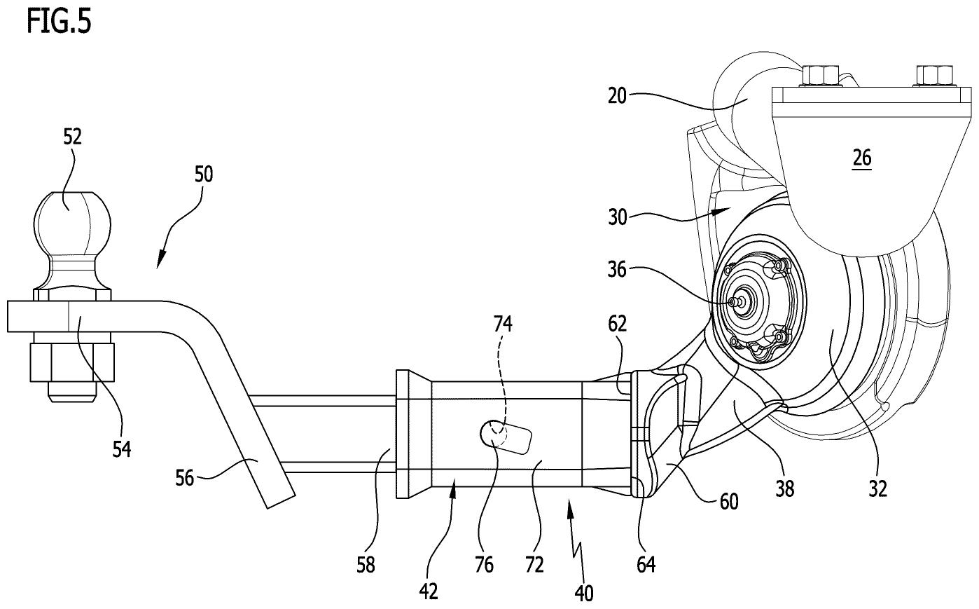

In a first exemplary embodiment, an attachment element carrier 40 extends from the pivot element 32 and comprises a connection arm 38 which extends from the pivot element 32 and to which is connected a receiving body, designated 42 as a whole, wherein the receiving body 42 forms an insertion receptacle 46 that extends therein along a center axis 44, wherein, as illustrated in FIGS. 2 and 5, insertable in a receiving opening 48 that is opposed to the direction of forward travel is, for example as an attachment element 50, a coupling ball carrier 56 that carries at an end 54 a coupling ball 52 and is insertable in the receiving opening 48 by an opposite end region 58 to the end 54.

As illustrated in FIG. 1, in a working position A the attachment element carrier 40 is arranged relative to the bumper unit 16 such that it extends below a lower edge 18 of the bumper unit 16, that is to say on a side thereof that faces a road surface 28, and thus the insertion receptacle 46 is freely accessible for insertion of the end region 58 of the coupling ball carrier 56, wherein in the working position A the center axis 44 extends in the vehicle longitudinal center plane or the longitudinal center plane 34 of the holding device 20.

In particular, in the case of a pivot axis 36 that runs transversely, in particular obliquely, to the vehicle longitudinal center plane 34, it is provided for the insertion receptacle 46 to extend with its center axis 44 transverse to the longitudinal center plane 34 in the rest position R, and in so doing in particular to run such that it is inclined relative to the direction of the road surface 28.

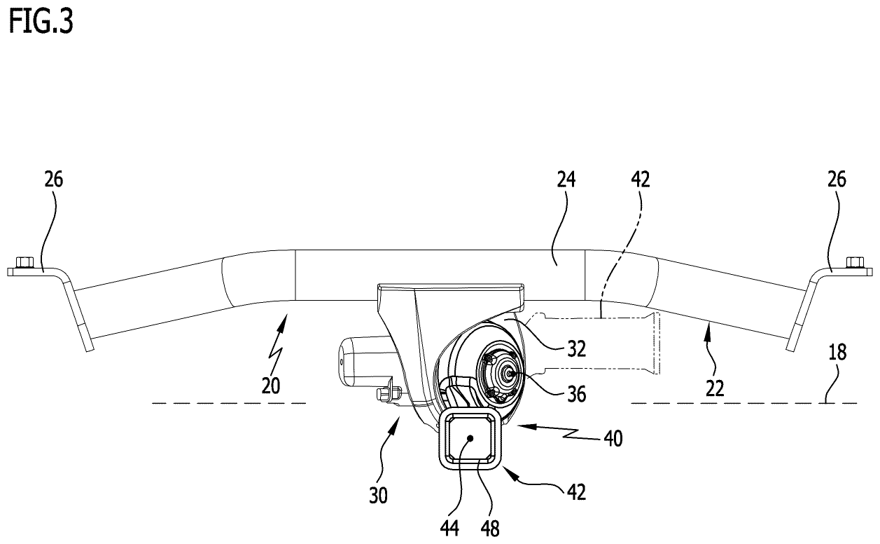

Because the pivot element 32 is mounted such that it is pivotal about the pivot axis 36, it is possible, as illustrated in FIG. 3, to pivot the attachment element carrier 40 from the working position A, in which the receiving body 42 is below the lower edge 18 of the bumper unit 16, under the lower edge 18 and through into a rest position R illustrated in dashed lines in FIG. 3, in which the attachment element carrier 40 and thus in particular also the receiving body 42 lie above the lower edge 18 of the bumper unit 16 such that they are hidden by the bumper unit 16 and are thus arranged outside a visible region of the bumper unit 16 and the body 12, wherein in the rest position R the center axis 44 extends transversely to the vehicle longitudinal center plane 34 or the longitudinal center plane 34 of the holding device 20.

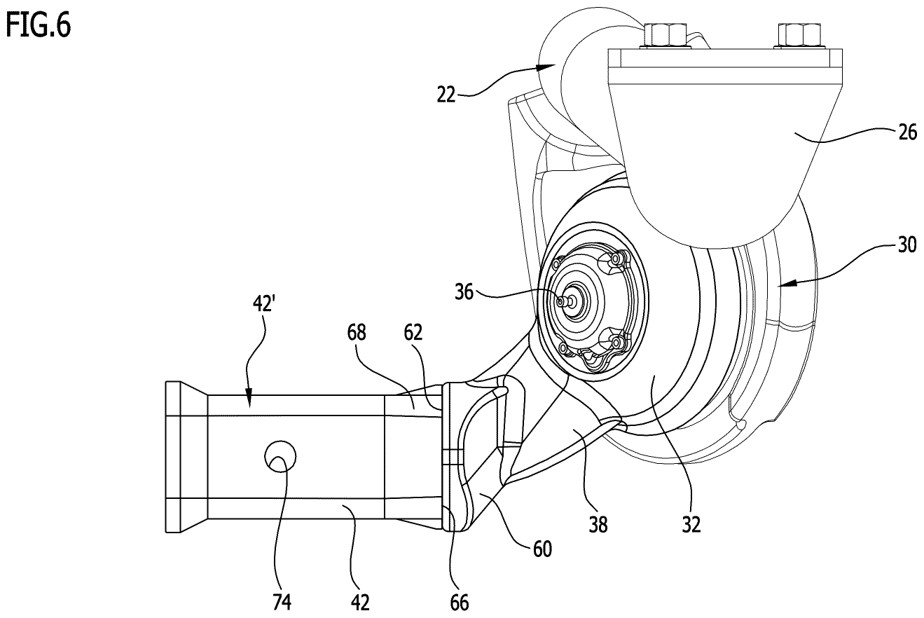

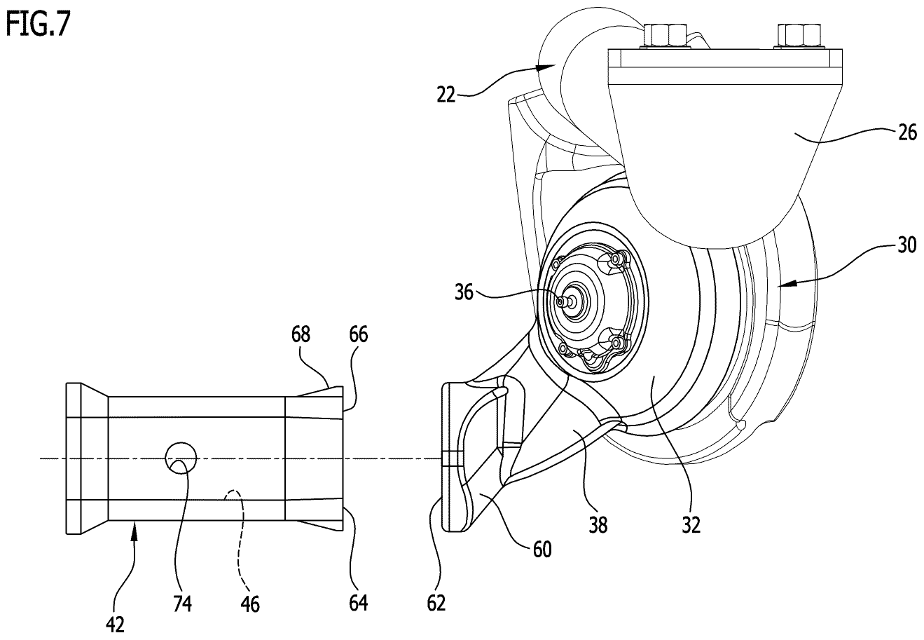

As illustrated in FIGS. 5 to 7, arranged on, and in particular integrally formed in one piece with, the connection arm 38 that extends from the pivot element 32 is a connecting body which is designated 60 as a whole and which has a holding face 62 that runs transversely, in particular perpendicular, to the center axis 44 of the insertion receptacle 46 and is connected to a support face 64 of a weld lug 68 of the receiving body 42.

Preferably, the support face 64 is configured as an annular face 66 of the weld lug 68 of the receiving body 42, and runs in a manner concentric with the center axis 44.

The connection between the annular face 66 and the holding face 62 is made by rotary friction welding, wherein the receiving body 42, rotating coaxially with the center axis 44, is pressed with the annular face 66 against the holding face 62, which is arranged not to rotate, such that, as a result of friction between the annular face 66 and the holding face 62, the material forming the holding face 62 and the annular face 66, in particular steel, heats to welding temperature, and a material layer is formed at welding temperature between the annular face 66 and the holding face 62, wherein once rotation of the annular face 66 ends the material layer hardens and permanently connects the connecting body 60 to the receiving body 42.

For the purpose of fixing the end region 58 of the attachment element 50 in the receiving body 42, in the region of the mutually opposite side walls 72 of the receiving body 42 it is provided with a respective passage opening 74 through which is passable a holding bolt 76 that likewise passes through an opening (not illustrated) in the portion of the end region 58 of the attachment element 50 that is inserted in the insertion receptacle 46, in order to fix the end region 58 in the receiving receptacle 42.

In a second exemplary embodiment, the holding device 20 and the carrier unit 22 and transverse carrier 24 and connection elements 26 take the same form as in the first exemplary embodiment.

Further, the pivotal bearing unit 30, with the pivot element 32 and the pivot axis 36, also take the same form as in the first exemplary embodiment.

Moreover, the attachment element carrier 40′, with the receiving body 42′ and the center axis 44, are also oriented in the same way in the working position A and the rest position R as described in the case of the above exemplary embodiment.

Unlike the above exemplary embodiment, the attachment element carrier 40′ forms a connecting body 80 that is in particular integrally formed in one piece with the connection arm 38, in particular taking the form of a body part 82 of the receiving body 40′ that is held on the connection arm 38.

Here, in relation to the working position A, the body part 82 comprises a side wall 84 and, adjoining this side wall 84 on either side, transverse walls 86, 88, with the result that the body part 82 takes the shape of a U overall and in the working position A delimits the insertion receptacle 46′, at a longitudinal side 94 by way of the side wall 84, at an upper side 96 by way of the transverse wall 86, and at a lower side 98 by way of the transverse wall 88.

On the open side 90 of the body part 82 that is opposite the side wall 84, for example facing away from the connection arm 38, a separate side wall 102 is inserted between the transverse walls 86 and 88 as a supplementary body part 100 of the receiving body 42′, wherein the side wall 102 forms a further longitudinal side 104 of the insertion receptacle 46′, opposite the longitudinal side 94, and is connected to the transverse walls 86 and 88 by welding.

The connection to the transverse walls 86 and 88 is made in particular by friction stir welding using a rotating friction stir head 114 which has a conical tip 112 and is driven such that it rotates about its own axis of symmetry 116 and moves along a gap 118 between the transverse walls 86, 88 and an outer edge of the separate side wall 102 forming the supplementary body part 100.

So that, during friction stir welding, the separate side wall 102 that in particular forms the supplementary body part 100 can be positioned in a defined manner relative to the body part 82 connected to the connection arm 38, in the illustrated exemplary embodiment relative to the transverse walls 86 and 88, the body part 82 is provided in the region of the transverse walls 86 and 88 with respective steps 126 and 128, which form bearing faces 132 and 134 running at a defined spacing from the longitudinal side 94 of the side wall 84 and form positioning faces 136 and 138 that receive the separate side wall 102 forming the supplementary body part 100 between them in a defined manner, by way of their side edges 130, and respectively delimit the gap 118.

The material into the gap 118 that is melted by friction stir welding, in particular molten steel, solidifies as it cools, resulting in a permanently firm connection between the part body 82 and the separate side wall 102, with the result that the receiving body 42′ has the required stability.

In the second exemplary embodiment, the side wall 84 and the separate side wall 102 are provided with the passage openings 74′ for the holding bolt 76 for the purpose of securing the end region 58 of the attachment element 50.

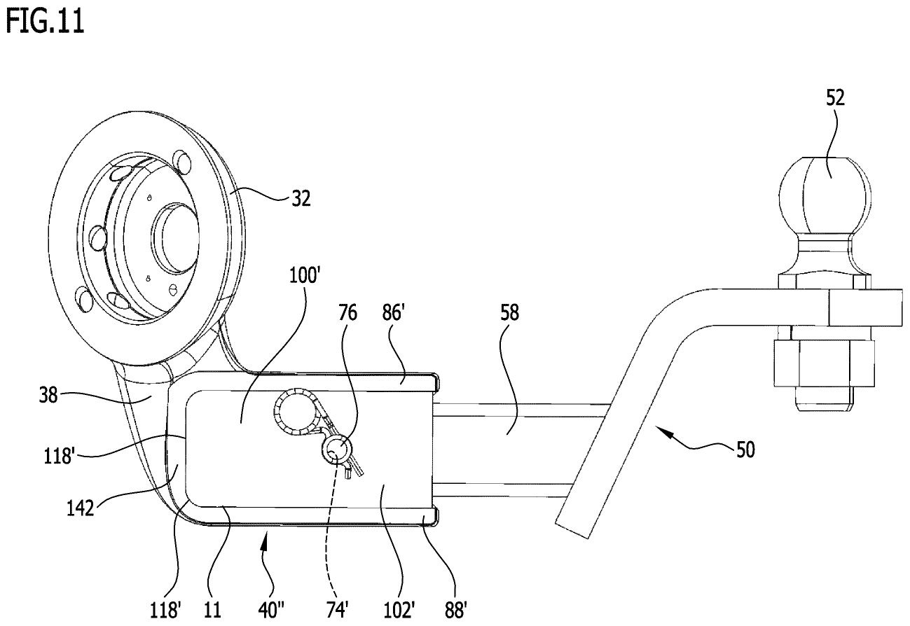

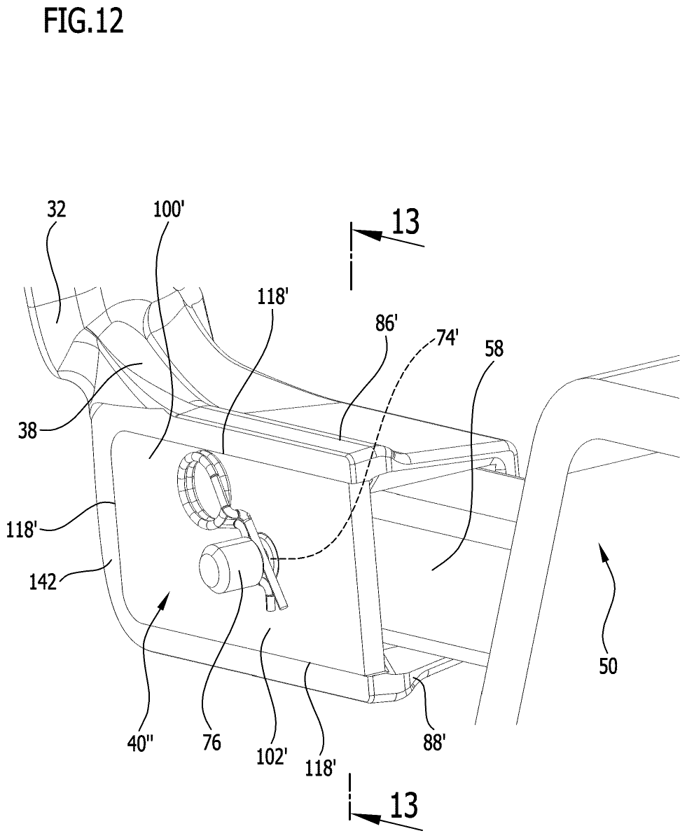

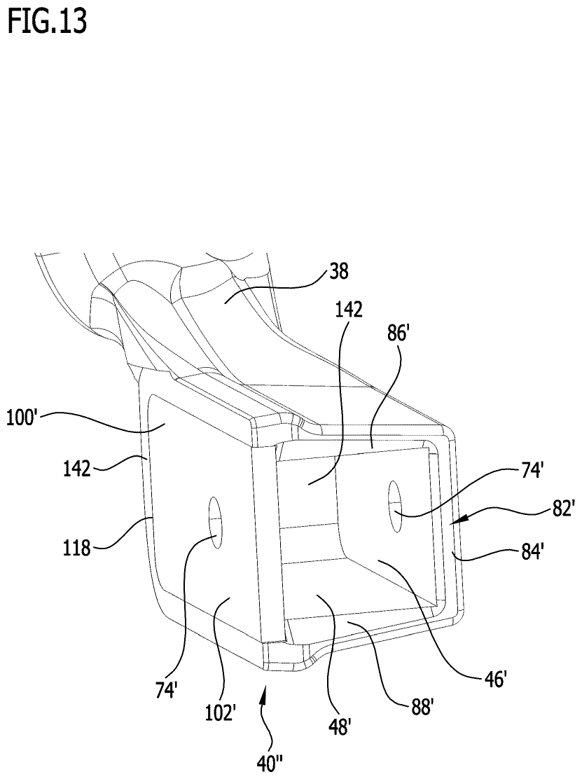

In a third exemplary embodiment, illustrated in FIGS. 11 to 13, which represents a modification of the second exemplary embodiment, reference is made to the second exemplary embodiment in its entirety unless explicitly described otherwise below.

Unlike the second exemplary embodiment, as a supplementary body part 100′, inserted into the part body 82′ on an open side that faces the connection arm 38 is a separate side wall 102′, which in this case is not only connected to the transverse walls 86′ and 88′ but also to an end wall 142 of the attachment element carrier 40″ that is integrally formed on the connection arm 38, with the result that the insertion receptacle 46′ is closed off by the end wall 142 on its opposite side to the receiving opening 48′.

In this exemplary embodiment, the gap 118′ along the outer side of the separate side wall 102′ thus runs along the upper transverse wall 86′, along the end wall 142 and then along the lower transverse wall 88′, or vice versa.

In the third exemplary embodiment too, the connection to the transverse walls 86′ and 88′ and the end wall 142 is made along the gap 118′ by friction stir welding, as described in the second exemplary embodiment.

As an alternative, in the second and third exemplary embodiments it is, however, also possible to make the connection between the part body 82 or 82′ and the separate side wall 102, 102′, along the gap 118 or 118′, by laser welding.

1. A holding device that is mountable on a rear region of the body of a motor vehicle, comprising a pivotal bearing unit, which is mountable in a manner fixed to the vehicle on the rear region of a motor vehicle, in particular a passenger car, by a carrier unit, and on which a pivot element that carries an attachment element is mounted to pivot about a pivot axis running transversely, in particular obliquely, to a longitudinal center plane and is thus pivotal from a working position to a rest position and vice versa,
wherein by way of a connection arm the pivot element is provided with an attachment element carrier that has an insertion receptacle in which an attachment element is insertable and fixable with positive engagement by an end region, wherein in the working position the insertion receptacle extends with its center axis substantially parallel to the longitudinal center plane, and wherein the attachment element carrier comprises a receiving body that has the insertion receptacle, wherein the receiving body is connected to the connection arm by a connecting body that is integrally formed in one piece with the connection arm.

2. The holding device as claimed in claim 1, wherein the receiving body and the connecting body are connected to one another by pressure welding.

3. The holding device as claimed in claim 2, wherein the receiving body and the connecting body are connected to one another by friction welding.

4. The holding device as claimed in claim 3, wherein the receiving body is connected to the connecting body by rotary friction welding.

5. The holding device as claimed in claim 4, wherein the rotary friction welding is performed by rotating the receiving body about an axis that is parallel to its center axis, in particular about the center axis thereof.

6. The holding device as claimed in claim 4, wherein the receiving body is provided as a finished body with a weld lug that is connected to the connecting body by friction welding.

7. The holding device as claimed in claim 6, wherein the weld lug of the receiving body is arranged on an opposite side to an insertion opening.

8. The holding device as claimed in claim 6, wherein the connecting body has a holding face, which faces the receiving body and to which a support face of the weld lug is connected by friction welding.

9. The holding device as claimed in claim 1, wherein the connecting body forms a body part of the receiving body.

10. The holding device as claimed in claim 8, wherein the body part forms at least one wall of the receiving body, which is connected to at least one body part of the receiving body that supplements this body part.

11. The holding device as claimed in claim 10, wherein the body part and the at least one supplementary body part are connected to one another by pressure welding.

12. The holding device as claimed in claim 11, wherein the body part and the at least one supplementary body part are connected to one another by friction stir welding, in particular along a gap formed between the body part and the at least one supplementary body part abutting against it.

13. The holding device as claimed in claim 12, wherein, for the purpose of connecting the body parts, one of them is provided with steps for receiving side edges in a defined manner and thus for positioning the other body part such that the gap is formed between them.

14. The holding device as claimed in claim 9, wherein the body part forms at least two walls of the receiving body.

15. The holding device as claimed in claim 14, wherein the body part takes the shape of a U and forms three walls of the receiving body.

16. The holding device as claimed in claim 15, wherein in the working position the body part forms a side wall and two transverse walls respectively adjoining a side thereof.

17. The holding device as claimed in claim 16, wherein the side wall and the transverse walls are connected in one piece with one another.

18. The holding device as claimed in claim 17, wherein the transverse walls are connected to one another, on an opposite side to the side wall, by a side wall of the supplementary body part.
